(19) United States
(12) Patent Application Publication
(10) Pub. No.: US 2019/0265097 A1
(43) Pub. Date: Aug. 29, 2019

(54) METHOD AND DEVICE FOR THE FUNCTIONAL TESTING OF A FIBRE-OPTIC SENSOR AND COMPUTER PROGRAM PRODUCT

(71) Applicant: fos4X GmbH, München (DE)

(72) Inventor: Mathias Müller, Gröbenzell (DE)

(21) Appl. No.: 16/334,735

(22) PCT Filed: Sep. 11, 2017
(86) PCT No.: PCT/EP2017/072750

§ 371 Date: Mar. 19, 2019

(30) Foreign Application Priority Data
Sep. 20, 2016 (DE) 10 2016 117 691.5

(51) Int. Cl. G01H 9/00; G01D 18/00; G01L 1/24; F03D 17/00; G01D 5/353; G01P 15/093

(52) U.S. Cl. CPC G01H 9/004; G01D 18/00; G01L 1/24; F05B 2270/804; G01D 5/353; G01P 15/093; F03D 17/00

(57) ABSTRACT

The invention relates to a method (200) for the functional testing of a fibre-optic sensor (110). The method (200) comprises receiving (220) optical sensor signals of the fibre-optic sensor (110) in an evaluation unit (124), determining (230) a first variable from the optical sensor signals, determining (240) whether the first variable lies within a pre-determined range, determining (250) a malfunction of the fibre-optic sensor (110) if the first variable lies outside the pre-determined range, and determining (260) a second variable from the optical sensor signals, which is different from the first variable, if it is determined that the first variable lies within the pre-determined range, the second variable declaring a parameter that is to be determined by the fibre-optic sensor (110).

The disclosure relates to a method and a device for functional testing of a fibre-optic sensor, and relates to a computer program product. In particular, the present disclosure relates to determining a defect of a measurement system that uses the fibre-optic sensor.

### PRIOR ART

Fibre-optic sensors may be used for monitoring technical installations. The fibre-optic sensors supply measurement signals, which, for example, may indicate a state of the technical system. Deviations of the measured signals, for example due to a malfunction of a fibre-optic sensor, may lead to erroneous state determinations of the technical installation.

Therefore, it is necessary to provide a method and a device for functional testing of a fibre-optic sensor.

### DISCLOSURE OF THE INVENTION

It is the object of the present disclosure to specify a method and a device for functional testing of a fibre-optic sensor, as well as a computer program product, which enable a detection of a malfunction of a fibre-optic sensor. This object is achieved via the subject matter of the independent claims.

A method for functional testing of a fibre-optic sensor is specified according to embodiments of the present disclosure. The method includes receiving optical sensor signals of the fibre-optic sensor in an evaluation unit; determining a first variable from the optical sensor signals; determining whether the first variable is within a predetermined range; determining a malfunction of the sensor if the first variable is outside of the predetermined range; and determining a second variable from the optical sensor signals, said second variable being different than the first variable, if it is determined that the first variable is within the predetermined range, wherein the second variable indicates a parameter that is to be determined by the fibre-optic sensor.

A device for functional testing of a fibre-optic sensor is specified according to a further aspect of the present disclosure. The device comprises a receiving unit for receiving optical sensor signals that are output by the fibre-optic sensor and an evaluation unit. The evaluation unit is configured to determine a first variable from the optical sensor signals; determine whether the first variable is within a predetermined range; determine a malfunction of the fibre-optic sensor if the first variable is outside of the predetermined range; determine a second variable from the optical sensor signals, said second variable being different than the first variable, if it is determined that the first variable is within the predetermined range, wherein the second variable indicates a parameter that is to be determined by the fibre-optic sensor.

A computer program product with a software is specified according to another aspect of the present disclosure. The software is configured to determine a first variable from the optical sensor signals of a fibre-optic sensor; to determine whether the first variable is within a predetermined range; to determine that a malfunction of the fibre-optic sensor is present if the first variable is outside of the predetermined range; to determine a second variable from the optical sensor signals, said second variable being different than the first variable, if it is determined that the first variable is within the predetermined range, wherein the second variable indicates a parameter that is to be determined by the fibre-optic sensor.

Preferred, optional embodiments and particular aspects of the disclosure result from the dependent claims, the drawings, and the present description.

According to the embodiments of the present disclosure, the optical sensor signals are used in order to first perform a plausibility check using the first variable determined therefrom. If the first variable appears to not be plausible, a malfunction of the measurement system may thus be concluded, for example a malfunction of the fibre-optic sensor, of an evaluation unit, and/or of devices for data exchange between sensors and evaluation unit. However, if the first variable appears to be plausible, a second, different variable is determined from the optical sensor signals, which second variable, for example, indicates a parameter to be determined, for example a parameter of a technical installation. It may thus be reliably detected whether the measurement signals are correct, or else are to be attributed to a malfunction of the fibre-optic sensor, for example.

### BRIEF DESCRIPTION OF THE DRAWINGS

Exemplary embodiments of the disclosure are presented in figures and are described in greater detail below. Shown are:

FIG. 1A a schematic illustration of a device for functional testing of a fibre-optic sensor in accordance with embodiments of the present disclosure,

FIG. 1B a schematic illustration of a device for functional testing of a fibre-optic sensor in accordance with further embodiments of the present disclosure,

FIG. 2 a flow chart of a method for functional testing of a fibre-optic sensor in accordance with embodiments of the present disclosure, and

FIG. 3 an illustration of an optical sensor signal in accordance with embodiments of the present disclosure.

### EMBODIMENTS OF THE DISCLOSURE

In the following, unless otherwise noted, the same reference numerals are used for identical and identically acting elements.

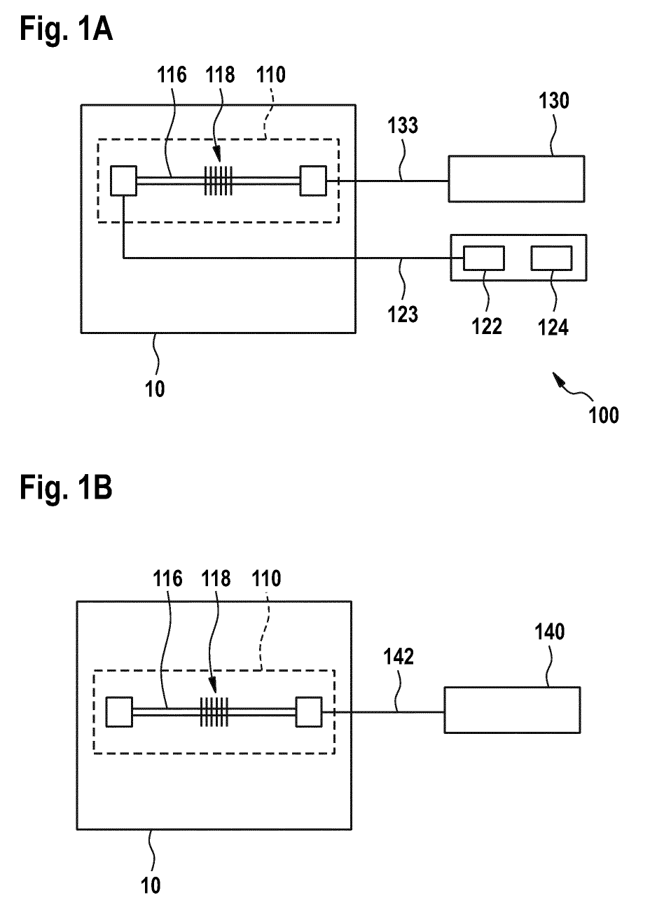

FIG. 1A shows a schematic illustration of a device 100 for functional testing of a fibre-optic sensor 110 in accordance with embodiments of the present disclosure. The fibre-optic sensor 110 is thereby shown only by way of example. Other types of fibre-optic sensors may be used for the embodiments of the present disclosure.

The device 100 comprises: a receiving unit 122 for receiving optical sensor signals that are output by the fibre-optic sensor 110; and an evaluation unit 124. The evaluation unit 124 is configured to determine a first variable from the optical sensor signals; determine whether the first variable is within a predetermined range; determine a malfunction of the fibre-optic sensor 110 if the first variable is outside of the predetermined range; determine a second variable from the optical sensor signals, said second variable being different than the first variable, if it is determined that the first variable is within the predetermined range, wherein the second variable indicates a parameter that is to be determined by the fibre-optic sensor 110.

According to the present disclosure, a malfunction of the fibre-optic sensor of a measurement system may be concluded if the first variable is outside of the predetermined range. It may thus be reliably detected whether the measurement signals are correct, or else are to be attributed to a malfunction of the fibre-optic sensor, for example. According to embodiments, malfunctions of other elements of the measuring system may also be concluded, for example malfunctions of the evaluation unit 124 itself and/or of devices for data exchange between fibre-optic sensors 110 and evaluation unit 124.

According to embodiments, the fibre-optic sensor 110 may be used in an energy plant, for example a wind power plant. For example, the fibre-optic sensor 110 may be integrated into a rotor blade 10 of the wind power plant or be arranged on a surface of the rotor blade 10. However, the present disclosure is not limited to this, and the fibre-optic sensor 110 may be arranged in other parts of the wind power plant, for example a hub at which the rotor blade is borne so as to be rotatable. According to embodiments that may be combined with other embodiments described here, the fibre-optic sensor is selected from the group consisting of acceleration sensors, torsion sensors, temperature sensors, and any combinations thereof.

The fibre-optic sensor 110 presented by way of example in FIG. 1A is connected to a light source 130 that is configured to emit polarized or unpolarized light. The light source 130 may, for example, be a polarizing light source that emits polarized light, or may be optically connected with a polarizer. The light source 130 may be connected to the fibre-optic sensor 110 via a first optical waveguide laser 133.

According to embodiments, the light source 130 and the device 100 may be connected to one another. For example, the device 100 may receive from the light source 130 data with regard to a light emission, and/or may be configured to control the light source 130 for a light emission. The light source 130 may be integrated into the device 100 or may be provided separately from the device 100. Alternatively, the light source 130 may be integrated into the fibre-optic sensor 110.

The fibre-optic sensor 110 of FIG. 1A comprises a second optical waveguide fibre 116 that is optically connected to the output of the light source 130, for example via the first optical waveguide fibre 133. A Bragg grating 118 may be present in the second optical waveguide fibre 116. A third optical waveguide fibre 123 is provided to supply the light traveling through the second optical waveguide fibre 116 to the receiving unit 122 of the device 100. The light reaching the receiver unit 120 may thereby correspond to the optical sensor signals from which the first variable and the second variable are determined.

In the example of FIG. 1A, the light emitted by the light source 130 travels through the first optical waveguide fibre 133 to the fibre-optic sensor 110, then is altered or modulated by the Bragg grating 118 in the second optical waveguide fibre 116, and then travels via the third optical waveguide fibre 123 to the evaluation unit 124. The light thereby travels in separated optical waveguide fibres to the fibre-optic sensor 110 or away from the fibre-optic sensor 110.

FIG. 1B shows a further example of a measurement system with a fibre-optic sensor 110 that is connected to the device 140 in accordance with the embodiments described here. In the example of FIG. 1B, the light emitted from the light source is directed to the fibre-optic sensor via an optical waveguide fibre 142. Light reflected by the Bragg grating 118 of the fibre-optic sensor 110 travels back to the device 140 via the same optical waveguide fibre 142 and is evaluated there by the evaluation unit in order to determine the first variable and/or the second variable. According to embodiments, the light source may be integrated into the device 140, or may be provided separately from the device 140, as is shown by way of example in FIG. 1A.

A computer program product with a software is specified according to an aspect of the present disclosure. The software may be implemented in the device, and in particular in the evaluation unit, according to the embodiments described here. The software is configured in order to implement the functional testing of the fibre-optic sensor described herein.

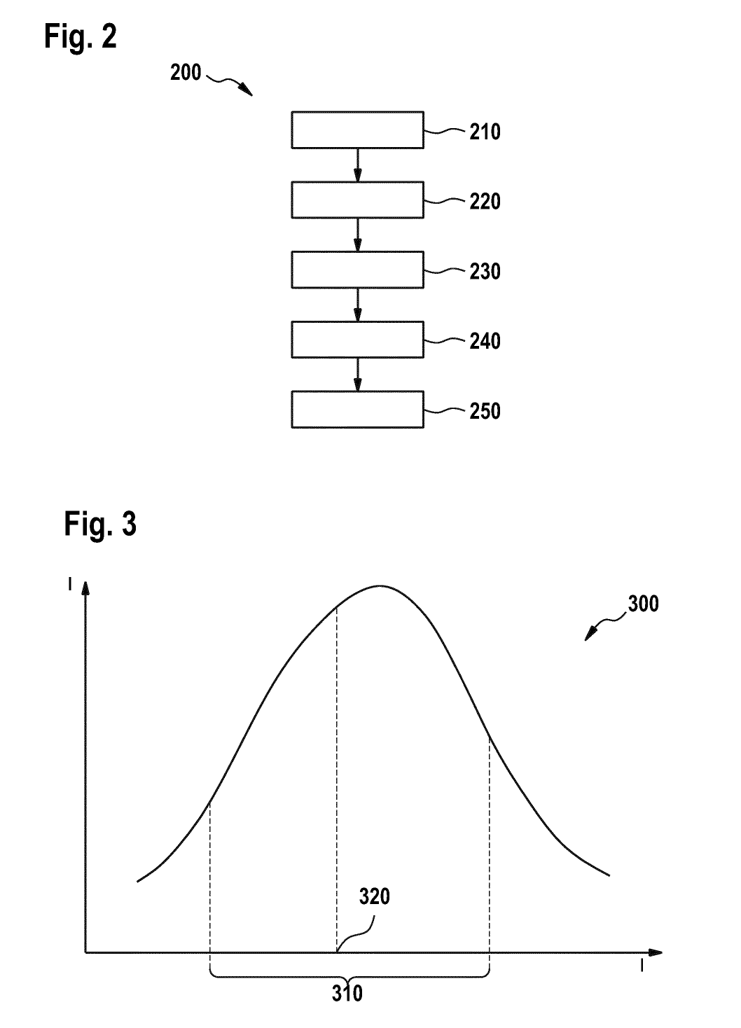

FIG. 2 shows a flow chart of a method 200 for functional testing of a fibre-optic sensor in accordance with embodiments of the present disclosure.

The method 200 includes receiving optical sensor signals of the fibre-optic sensor in an evaluation unit in step 210; determining a first variable from the optical sensor signals in step 220; determining whether the first variable is within a predetermined range in step 230; determining a malfunction of the fibre-optic sensor if the first variable is outside of the predetermined range in step 240; and determining in step 250 a second variable from the optical sensor signals, which is different from the first variable, if it is determined that the first variable is within the predetermined range. The second variable indicates a parameter that is to be determined by the fibre-optic sensor.

The optical sensor signals may be generated in that light is supplied to the fibre-optic sensor, which light is altered or modulated by the fibre-optic sensor, and in particular by the Bragg grating. For example, the light may pass through the fibre-optic sensor as shown in FIG. 1A. In other examples, the light may be at least partially reflected by the fibre-optic sensor, as shown in FIG. 1B.

According to embodiments, the fibre-optic sensor may be used in a technical installation, for example in a wind power plant. In particular, the fibre-optic sensor may be mounted in or on the installation, for example on a rotor blade of the wind power plant as described with reference to FIG. 1.

The parameter that is indicated by the second variable may, for example, be an operating parameter, environment parameter, or installation parameter with regard to the technical installation and/or its surroundings. The second variable indicates the parameter itself or a value of the parameter. For example, the second variable may be selected from the group consisting of a natural frequency of a rotor blade, a temperature, an angle of attack of the rotor blade, a pitch angle, a wind speed, and a speed of incidence. The operating parameters may, for example, include a natural frequency of a rotor blade, an angle of attack, a pitch angle, an angle of incidence, a speed of incidence, and a rotation speed of the rotor blade. The environmental parameters may include wind speed and an ambient temperature or external temperature, for example. The installation parameters may be installation-specific parameters, for example a location, a height of a nacelle of the wind power plant, and a length of the rotor blades.

Typically, the angle of attack is defined with respect to a reference plane. The pitch angle may indicate an angular adjustment of the rotor blade with respect to a hub at which the rotor blade is borne so as to be able to rotate. The speed of incidence may indicate a relative speed or relative mean speed at which the air impinges on the rotor blade. The wind speed may indicate an absolute wind speed. The temperature may be an ambient temperature or an external temperature.

According to embodiments, one or more parameters (for example, known additional parameters) may be used for determining the second variable and/or the parameter. The one or more additional parameters may be selected from the aforementioned group consisting of operating parameters, environmental parameters, and the installation parameters thereof.

Both the first variable and the second variable are determined from the optical sensor signals of the fibre-optic sensor. The first variable and the second variable are thereby different. The first variable may be determined via a first evaluation. The second variable may be determined by a second evaluation which takes place differently than the first evaluation.

According to embodiments, the first evaluation may take place independently of properties or features of the technical installation, for example a geometry and/or mass of a rotor blade. For example, the first evaluation may take place without or independently of the operating parameters, environmental parameters, and installation parameters. In other words, the first evaluation may, for example, use no properties or features of the technical installation for the determination of the first variable. By contrast, the second evaluation may use such properties or features of the technical installation, and may in particular use the operating parameters, environmental parameters, and/or installation parameters. For example, the determination of the natural frequency of the rotor blade, which represents the second variable, may take place using a geometry and/or mass of the rotor blade.

According to embodiments, the predetermined range may be defined by a sensor-specific reference value or normal value. In particular, the predetermined range may be a range in which it may be assumed that the sensor is functioning correctly under normal circumstances, thus exhibits no malfunction. For example, if the first variable corresponds to the reference value or is within the predetermined range around the reference value, the fibre-optic sensor exhibits no malfunction. However, if the first variable is outside of the predetermined range, the presence of a malfunction is detected.

The predetermined range may, for example, be defined by a predetermined percentile deviation from the reference value. For example, the reference deviation may correspond to a deviation of 5%, 10%, 15%, or 20% from the reference value.

According to embodiments that may be combined with other embodiments described here, the first variable may correspond to an optical property of the optical sensor signals. For example, the first variable may be selected from the group consisting of an intensity of the optical sensor signals and a polarization of the optical sensor signals. In particular, the determination of the intensity or polarization may take place without knowledge or use of the properties or features of the technical installation. An example of a determination of the first variable from an intensity of the optical sensor signals is explained with reference to FIG. 3.

For example, if the intensity (thus the first variable) corresponds to a reference intensity or is within a predetermined range around the reference intensity, the fibre-optic sensor exhibits no malfunction. However, if the measured intensity is outside of the predetermined range, the presence of a malfunction is detected.

According to embodiments, the fibre-optic sensor may provide the optical sensor signals continuously or at time intervals. In other words, a measurement by the fibre-optic sensor may take place continuously or at time intervals. The determination of the first variable from the optical sensor signals may thereby take place before, during, and/or after such a measurement. For example, relevant parts of the state monitoring system may have their function checked directly before, during, or directly after a measurement. The relevant parts may, for example, comprise the sensors, the evaluation unit, and/or devices for exchanging measurement data between sensors and evaluation unit.

According to the embodiments, a monitoring occurs as to whether the signal level of the signal emanating from the fibre-optic sensor is within a sensor-specific defined range. A plausibility check of the level may be performed at software level. The level of a measurement signal, or of a test signal specifically detected for the testing, may thereby be used.

In particular, in some embodiments an optical input signal may be used for a measurement in order to obtain the optical sensor signals that are output signals. The optical sensor signals obtained in such a manner may be used for determining the first variable and determining the second variable. According to embodiments, the same optical sensor signals of a measurement may be used for the determination of the first variable and second variable.

At least one first optical sensor signal may thus be used for determining the first variable, and then after a positive plausibility check the first optical signal may also be used for the determination of the second variable. In other embodiments, different optical sensor signals of a single measurement may be used for determining the first variable and second variable. For example, at least one first optical sensor signal of the measurement may be used for determining the first variable, and then at least one second optical sensor signal of the measurement may be used for determining the second variable.

According to additional embodiments, one or more test signals may be used to generate or provide the optical sensor signals for determining the first variable. For this purpose, for example, the fibre-optic sensor may transmit a defined test signal to the evaluation unit at regular intervals. In particular, the fibre-optic sensor may automatically send the test signal to the evaluation unit, or it may send it to the evaluation unit upon a command signal from the evaluation unit.

In further examples, a defined test signal may be sent, for example, from the light source to the fibre-optic sensor for the generation of the optical sensor signals by the sensor to determine the first variable. The above-described optical input signals may be used for the generation of the optical sensor signals for determining the second variable. The test signals and the optical input signals for the measurement may be different. For example, a wavelength and/or a time interval of the test signals may be varied in order to obtain the optical sensor signals for determining the first variable. During functional testing using the test signals, a measurement for determining the second condition may be suspended or may not take place. The optical input signals and the test signals may be provided by the same light source, or may be provided by different light sources.

According to embodiments that may be combined with other embodiments described here, the determination of the first variable from the optical sensor signals does not take place at every measurement that is performed by the fibre-optic sensor. For example, the determination of the first variable from the optical sensor signals may take place at or after every x-th measurement that is performed by the fibre-optic sensor; x may be greater than 2, 10, 100, or 1000. Typically, the determination of the second variable from the optical sensor signals takes place at every measurement that is performed by the fibre-optic sensor.

According to embodiments that may be combined with other embodiments described here, the method 200 further includes outputting a message or alarm if the malfunction of the fibre-optic sensor is determined. For example, according to the embodiments described here the device may output a message or alarm in order to inform a user of the presence of the malfunction, for example of the fibre-optic sensor. For this purpose, the device may comprise a display device such as a screen. According to embodiments, the message or alarm may be output optically and/or acoustically.

According to embodiments, the fibre-optic sensor may be used in a wind power plant, and in particular in a measurement system for the wind power plant. The measurement system may be designed to determine a state of the rotor blade. For example, whether foreign material, such as ice, is being deposited on the rotor blade may be determined by determining the natural frequency of the rotor blade.

For this purpose, a measurement variable which correlates with the state of the rotor blades may be detected with one or more fibre-optic sensors in the rotor blades or in other parts of the wind power plant. For example, the natural frequencies of the blade may be monitored by means of acceleration sensors. Given a change of the state of the blade, for example due to damage, a change in the natural blade frequencies may then be observed. If damage is detected by the measurement system, it is not to be precluded without further measures that the cause is a defect within the measurement system. The reliability of the measurement system may be improved via the functional testing according to the invention.

FIG. 3 shows an illustration of an optical sensor signal 300 according to embodiments of the present disclosure.

The first variable may correspond to a property of the optical sensor signals. For example, the first variable may be an intensity of the optical sensor signal 300. The vertical axis in FIG. 3 thereby indicates the intensity, and the horizontal axis indicates a wavelength of the optical sensor signal 300. For example, an optical sensor signal may indicate an intensity over a predetermined wavelength range 310, as illustrated in the example of FIG. 3. In other words, a measurement over the predetermined wavelength range 310 may be performed in order to obtain an intensity or intensity distribution. The predetermined wavelength range 310 may be selected specific to a sensor. For example, the predetermined wavelength range 310 may include a range or be a range in which typical or known malfunctions of the fibre-optic sensor lead to significant deviations in the optical sensor signals, and therefore are clearly detectable.

However, the present disclosure is not limited to this, and in further examples the optical sensor signal may indicate an intensity at a specific wavelength. In other words, a measurement may be performed at a specific wavelength in order to obtain an intensity.

According to embodiments, the first variable may be a mean value of the optical property, for example the intensity, over the predetermined wavelength range 310. In further embodiments, the first variable may be a value at a selected wavelength 320 that, for example, is determined from the intensity distribution.

According to the embodiments of the present disclosure, the optical sensor signals are used in order to first perform a plausibility check using the first variable determined therefrom. If the first variable appears to not be plausible, a malfunction of the measurement system may thus be concluded, for example a malfunction of the fibre-optic sensor, of an evaluation unit, and/or of devices for data exchange between sensors and evaluation unit. However, if the first variable appears to be plausible, a second, different variable is subsequently determined from the optical sensor signals, which second variable, for example, indicates a parameter to be determined, for example a parameter of a technical installation. It may thus be reliably detected whether the measurement signals are correct, or else are to be attributed to a malfunction of the fibre-optic sensor, for example.

1. Method for functional testing of a fibre-optic sensor, comprising:
receiving optical sensor signals of the fibre-optic sensor in an evaluation unit;
determining a first variable from the optical sensor signals;
determining whether the first variable is within a predetermined range;
determining a malfunction of the fibre-optic sensor if the first variable is outside of the predetermined range;
determining a second variable from the optical sensor signals, which second variable is different than the first variable, if it is determined that the first variable is within the predetermined range, wherein the second variable indicates a parameter that is to be determined by the fibre-optic sensor.

2. The method according to claim 1, wherein the first variable corresponds to an optical property of optical sensor signals.

3. The method according to claim 1, wherein the first variable is selected from the group consisting of an intensity of the optical sensor signals and a polarization of the optical sensor signals.

4. The method according to claim 2, wherein the first variable is a mean value of the optical property over a predetermined wavelength range, or wherein the first variable is a value at a selected wavelength.

5. The method according to claim 4, wherein the fibre-optic sensor is used in a technical installation, and wherein the parameter is a parameter of the technical installation.

6. The method according to claim 5, wherein the second variable is determined from the first variable using installation-specific parameters.

7. The method according to claim 5, wherein the second variable is selected from the group consisting of a natural frequency of a rotor blade, a temperature, an angle of attack of the rotor blade, a pitch angle, a wind speed, and a speed of incidence.

8. The method of claim 1, wherein the determination of the first variable from the optical sensor signals does not take place at every measurement that is performed by the fibre-optic sensor.

9. The method according to claim 8, wherein the determination of the first variable from the optical sensor signals takes place at every x-th measurement that is performed by the fibre-optic sensor, and wherein x is greater than 2, 10, 100, or 1000.

10. The method according to claim 8, wherein the determination of the second variable from the optical sensor signals takes place at every measurement that is performed by the fibre-optic sensor.

11. The method according to claim 1, further comprising:
transmitting a test signal to the fibre-optic sensor in order to obtain the optical sensor signals for determining the first variable.

12. The method according to claim 1, further having:
outputting a message or an alarm if the malfunction is determined.

13. A device for functional testing of a fibre-optic sensor, comprising:
a receiving unit for receiving optical sensor signals that are output by the fibre-optic sensor; and
an evaluation unit that is configured to:
determine a first variable from the optical sensor signals;
determine whether the first variable is within a predetermined range;
determine a malfunction of the fibre-optic sensor if the first variable is outside of the predetermined range;
determine a second variable from the optical sensor signals, which second variable is different than the first variable, if it is determined that the first variable is within the predetermined range, wherein the second variable indicates a parameter that is to be determined by the fibre-optic sensor.

14. A computer program product comprising a software that is configured to:
determine a first variable from optical sensor signals of a fibre-optic sensor;
determine whether the first variable is within a predetermined range;
determine that a malfunction of the fibre-optic sensor is present if the first variable is outside of the predetermined range; and
determine a second variable from the optical sensor signals, which second variable is different than the first variable, if it is determined that the first variable is within the predetermined range, wherein the second variable indicates a parameter that is to be determined by the fibre-optic sensor.
